(19) United States
(12) Patent Application Publication
(10) Pub. No.: US 2026/0031888 A1
(43) Pub. Date: Jan. 29, 2026

(54) METHOD AND APPARATUS OF SUPPORTING BEAM PROBLEM PREDICTION

(71) Applicant: LENOVO (BEIJING) LIMITED, Beijing (CN)

(72) Inventors: Congchi ZHANG, Shanghai (CN); Jianfeng WANG, Beijing (CN); Bingchao LIU, Beijing (CN); Mingzeng DAI, Shanghai (CN); Xiaoying XU, Beijing (CN); Xin GUO, Beijing (CN)

(21) Appl. No.: 18/997,134

(22) PCT Filed: Jul. 21, 2022
(86) PCT No.: PCT/CN2022/107077

§ 371 Date: Jan. 20, 2025

(51) Int. Cl. H04B 7/06; H04B 17/318

(52) U.S. Cl. CPC H04B 7/06964; H04B 7/0626; H04B 17/328

(57) ABSTRACT

Embodiments of the present application relate to a method and apparatus of supporting beam problem prediction. An exemplary method may include: receiving configuration information on at least one set of RSs related to beam monitoring; and transmitting reporting information related to at least one beam problem, wherein the at least one beam problem is predicted by at least monitoring the at least one set of RSs related to beam monitoring.

### TECHNICAL FIELD

Embodiments of the present application are related to wireless communication technology, especially, related to artificial intelligence (AI) application in wireless communication, e.g., a method and apparatus of supporting beam problem prediction.

### BACKGROUND OF THE INVENTION

AI, at least including machine learning (ML) is used to learn and perform certain tasks via training neural networks (NNs) with vast amounts of data, which is successfully applied in computer vison (CV) and nature language processing (NLP) areas. Deep learning (DL), which is a subordinate concept of ML, utilizes multi-layered NNs as an “AI model” to learn how to solve problems and/or optimize performance from vast amounts of data.

By leveraging the advantage of AI, the performance of radio access network (RAN) network can be further optimized in at least the following use cases: energy saving, load balancing, traffic steering and mobility optimization. Thus, 3rd generation partnership program (3GPP) has been considering to introduce AI into 3GPP since 2016, including several study items and work items in SA1, SA2, SA5 and RAN3. However, there are still a mass of issues have not been discussed in 3GPP.

Taking beam failure recovery (BFR) as an example, in 3GPP release (Rel) 18, the AI capability for user equipment (UE) to predict beam quality changes in time domain will be studied to handle beam failure in a proactive way. For example, it is desired that the UE can indicate a possible beam failure in advance and propose new beam(s) (if any) to the RAN side before a beam failure is detected, so that the RAN side can adjust the beam before the real occurrence of a beam failure.

Therefore, the industry needs a technical solution at least supporting beam problem prediction to avoid potential beam failures and improve AI application in further long-term evolution (LTE) of RAN.

### SUMMARY

One objective of the embodiments of the present application is to provide a technical solution for wireless communication, especially for supporting beam problem prediction in wireless communication.

Some embodiments of the present application provide a remote apparatus, e.g., a UE, which includes: a transceiver; and a processor coupled to the transceiver, wherein the processor is configured to: receive, via the transceiver, configuration information on at least one set of reference signals (RS)s related to beam monitoring; and transmit, via the transceiver, reporting information related to at least one beam problem, wherein the at least one beam problem is predicted by at least monitoring the at least one set of RSs related to beam monitoring.

Some other embodiments of the present application provide a method performed in a remote apparatus, which includes: receiving configuration information on at least one set of RSs related to beam monitoring; and transmitting reporting information related to at least one beam problem, wherein the at least one beam problem is predicted by at least monitoring the at least one set of RSs related to beam monitoring.

In some embodiments of the present application, the predicted at least one beam problem includes one or more of the following:
it is predicted that a beam failure will be detected on a cell;
it is predicted that at least one beam failure instance indication for the at least one set of RSs related to beam monitoring will be received from lower layers;
it is predicted that a value of beam failure instance counter will be incremented or more than a threshold value;
it is predicted that a beam failure detection timer will start running;
it is predicted that L1-reference signal receiving power (RSRP) will be below a threshold value; and
it is predicted that block error rate (BLER) will be above a threshold value.

In some embodiments of the present application, the remote apparatus is configured to receive from the network side one or more of the following:
an indicator to enable or disable reporting predicted beam problems;
a first time window where whether there is a beam problem will be predicted;
a second time window where information on candidate beam(s) indicated in the reporting information is predicted;
a first confidence threshold, wherein in the case that occurrence likelihood of a beam problem is above the first confidence threshold, the beam problem will be considered as a predicted beam problem to be reported in the reporting information;
a second confidence threshold, wherein in the case that predicted information of a candidate beam has a confidence level above the second confidence threshold, the candidate beam will be considered as a candidate beam eligible to be reported in the reporting information;
a third threshold, wherein in the case that predicted quality of the set of RSs related to beam monitoring is worse than the third threshold, a beam problem will be predicted and reported in the reporting information;
a fourth threshold, wherein in the case that predicted quality of a candidate beam is better than or equal to the fourth threshold, the candidate beam will be considered as a candidate beam eligible to be reported in the reporting information;
a counter value, wherein in the case that predicted consecutive times of a beam failure instance is more than the counter value, a beam problem will be considered as a predicted beam problem to be reported in the reporting information;
a prohibition timer, wherein no reporting information will be transmitted when the prohibition timer is running; and
a time unit value that is used to set time information in the reporting information.

In some embodiments of the present application, the prohibition timer will start running in response to a beam failure is predicted or the reporting information is generated or transmitted successfully.

In some embodiments of the present application, the prohibition timer will be reset in the case that the at least one set of reference signals related to beam monitoring is reconfigured.

In some embodiments of the present application, no reporting information will be transmitted during a BFR procedure or during a random access procedure in response to a BFR.

In some embodiments of the present application, the reporting information is a predicted beam problem report, including one or more of the following:
information indicating whether there is a candidate beam is predicted for a cell where a beam problem is predicted;
information indicating a predicted L1-RSRP value or a BLER value of a candidate beam for a cell where a beam problem is predicted;
time information indicating validity time of the reporting information; and
confidence information indicating a confidence level of the reporting information.

In some embodiments of the present application, the reporting information is transmitted by a media access control (MAC) control element (CE), a channel state information (CSI) report, or a radio resource control (RRC) message.

According to some embodiments of the present application, in the case that the reporting information is transmitted by a MAC CE, the reporting information includes: a bit map indicating whether a beam problem is predicted in a cell. The MAC CE is associated with a logical channel identifier (LCID) different from legacy or same as legacy. In the case that the MAC CE is associated with a LCID as the same as legacy, a bit corresponding to a reserved bit in legacy MAC CE is used to indicate whether a relevant beam problem and candidate beam information for a corresponding cell is predicted or has occurred, and a field corresponding to a SP field in legacy MAC CE is used to indicate a predicted beam problem in a primary cell (PCell) or a primary secondary cell (PSCell).

According to some embodiments of the present application, in the case that the reporting information is transmitted by a CSI report, the CSI report includes an indicator indicating the at least one predicted beam problem. Exemplary CSI report includes information related to at least one predicted best beam or at least one best candidate beam when the predicted beam problem is going to happen.

According to some embodiments of the present application, in the case that the reporting information is transmitted by a RRC message, the reporting information is carried in an information element in a UE assistance information message.

In some embodiments of the present application, the reporting information is a beam measurement report in response to any of the following events occurred:
a beam failure is detected and corresponding beam failure recovery is successful;
a beam problem is predicted;
a beam problem is predicted and a corresponding predicted beam problem report has been transmitted; or
a beam problem is predicted, and a corresponding random access is successful.

According to some embodiments of the present application, the beam measurement report is a CSI report, and in the case that a protocol layer that predicts a beam problem is different from a protocol layer of the CSI report, the beam measurement report is triggered by a cross layer indication.

According to some embodiments of the present application, the beam measurement report is a RRC measurement report, and in the case that a protocol layer that predicts a beam problem is different from a RRC layer, the beam measurement report is triggered by a cross layer indication.

According to some embodiments of the present application, the reporting information is transmitted during or after a random access procedure initiated with a candidate beam, and indicates that the random access procedure is due to a predicted beam failure.

Some embodiments of the present application provide a RAN node, e.g., a gNB, which includes: a transceiver; and a processor coupled to the transceiver, wherein the processor is configured to: transmit, via the transceiver, configuration information on at least one set of RSs related to beam monitoring; and receive, via the transceiver, reporting information related to at least one beam problem, wherein the at least one beam problem is predicted by at least monitoring the at least one set of RSs related to beam monitoring.

Given the above, embodiments of the present application propose a technical solution of supporting beam problem prediction, and will facilitate the implementation of AI-based RAN.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 is a schematic diagram illustrating an exemplary wireless communication system according to some embodiments of the present application.

FIG. 2 illustrates an exemplary procedure of proactively handling a beam failure according to some embodiments of the present application.

FIG. 3 is a flow chart illustrating an exemplary procedure of a method of supporting beam problem prediction according to some embodiments of the present application.

FIG. 4 illustrates an exemplary MAC CE of reporting information related to predicted beam problems according to some embodiments of the present application.

FIG. 5 illustrates another exemplary MAC CE of reporting information related to predicted beam problems according to some other embodiments of the present application.

FIG. 6 illustrates an exemplary CSI report of information related to predicted beam problems according to some embodiments of the present application.

FIG. 7 illustrates a block diagram of an apparatus of supporting beam problem prediction according to some embodiments of the present application.

FIG. 8 illustrates a block diagram of an apparatus of supporting beam problem prediction according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, and so on. It is contemplated that along with the developments of network architectures and new service scenarios, all embodiments in the present application are also applicable to similar technical problems. Moreover, the terminologies recited in the present application may change, which should not affect the principle of the present application.

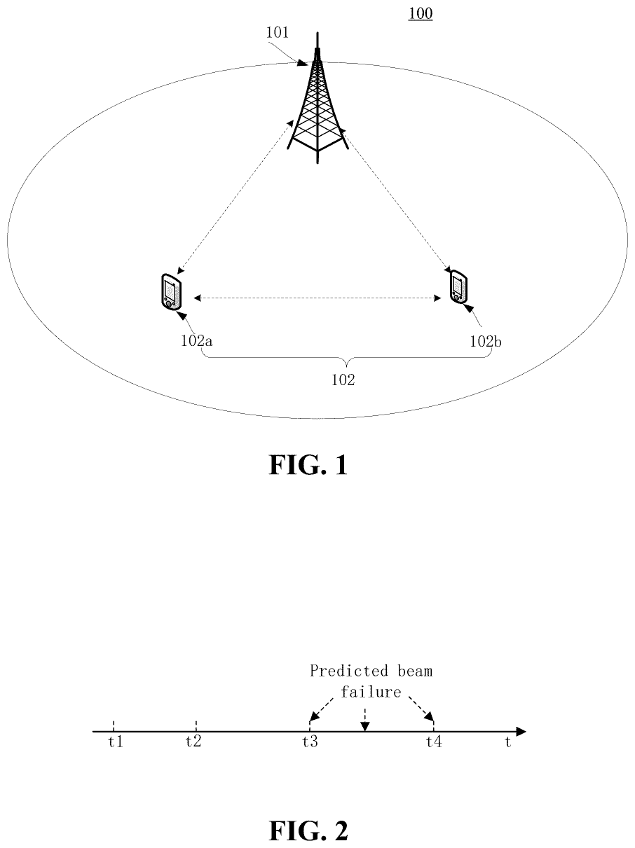

FIG. 1 illustrates a schematic diagram of an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two UE 102 (e.g., a first UE 102a and a second UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

The UE 102, e.g., the first UE 102a and second UE 102b should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

The UE 102, e.g., the first UE 102a and second UE 102b can be configured to monitor beams. Persons skilled in the art should well know that a beam can be expressed in various manners. In some embodiments of the present disclosure, a beam can be represented by a CSI-RS (or CSI-RS resource) or a synchronization signal (SS)/physical broadcast channel (PBCH) block (SSB) (or SSB resource). In the case of a beam failure being detected, the UE 102 will try to recover the beams by either performing random access following BFR related configuration in PCells and PSCells, or by generating and transmitting a BFR related MAC CE to the BS 101 in secondary cells (SCells). In response to receiving a random access request due to BFR or the BFR related MAC CE from the UE 102, the BS 101 may configure the UE 102 with a set of new beams in better quality.

It can be seen that, in legacy technology, handling of beam failure is quite passive because it is difficult for the network side to predict beam quality changes due to lack of related information, e.g., UE rotation, UE velocity, and UE speed etc. The network side only handles the beam failures detected and reported by the UE. Since the network side has to take time to configure new beams and the remote side has to take time to perform BFR, passive handling of beam failure will harm service continuity, especially continuity of uplink and downlink transmission.

Thus, in 3GPP Rel18, the AI capability for UE to predict beam quality changes in time domain will be studied to handle the beam failure in a proactive way.

FIG. 2 illustrates an exemplary procedure of proactively handling a beam failure according to some embodiments of the present application.

As shown in FIG. 2, the UE may predict there will be a beam problem (or a link problem), e.g., a beam failure in a future time window, e.g., at a future time instance (e.g., t3 or t4) or during a future time duration (e.g., from time t3 to t4) in time domain. The UE will report the predicted beam problem to the network side, e.g., to a gNB at time t1 before the predicted beam problem may happen. The UE may also indicate suggested new beams, e.g., one or more candidate beams with best predicted quality at the time that the predicated beam problem will occur, e.g., during the time duration from time t3 to t4. After receiving the predicted information from the UE, the gNB may adjust the beams for the UE at time t2, which is before the potential occurrence of the predicted beam problem. In this way, beam problems or link problems can be resolved proactively and the interruption to uplink and downlink transmission can be avoided. The time information, e.g., a time window or time period etc. where the beam problem prediction is performed can be configured by the network side. In some scenarios, in the case that the network side does not provide such time information, the UE will report the time information related to the predicted beam problem to the network side.

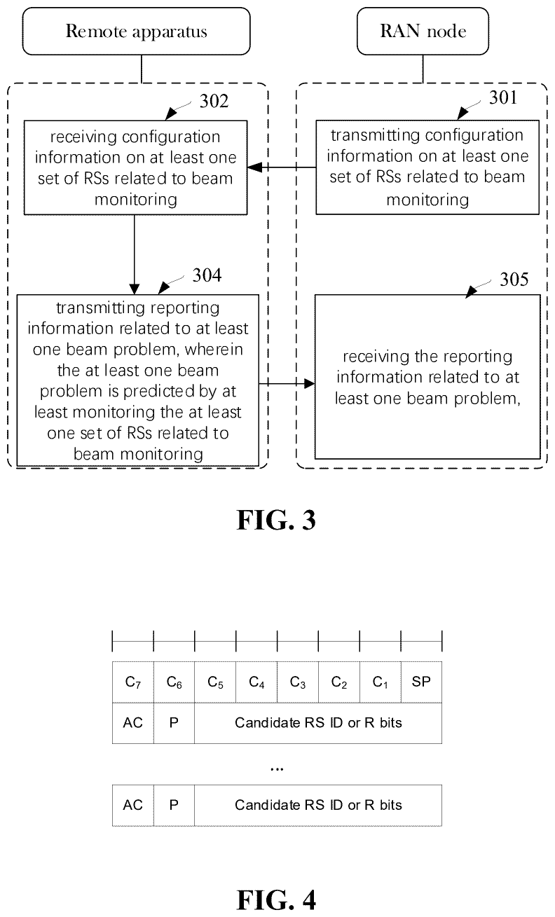

FIG. 3 is a flow chart illustrating an exemplary procedure of a method of supporting beam problem prediction according to some embodiments of the present application. Although the method is illustrated in a system level by a remote apparatus, e.g., a UE 102 as shown in FIG. 1 and a RAN node, e.g., a gNB 101 as shown in FIG. 1, persons skilled in the art can understand that the method implemented in the UE and that implemented in the BS can be separately implemented and incorporated by other apparatus with the like functions.

Referring to FIG. 3, a RAN node in the network side, e.g., a gNB may configure at least one set of RSs related to beam monitoring, e.g., at least one beam failure detection (BFD)-RS set for a remote apparatus, e.g., a UE, wherein each RS related to beam monitoring represents a beam. An exemplary set of RSs related to beam monitoring may include at least one of the following: a set of periodic CSI-RS resource configuration indexes or a set of SSB indexes. In step 301, the RAN node will transmit, to the remote apparatus, e.g., the UE, configuration information indicating the at least one set of RSs related to beam monitoring. For example, in some embodiments of the resent application, the RAN node may transmit the configuration information indicating at least one BFD-RS set including one or more CSI-RS resources to the UE by a RRC signaling. Accordingly, the remote apparatus will receive the configuration information indicating the at least one set of RSs related to beam monitoring in step 302.

In some other embodiments of the present application, the RAN node may also indicate at least one set of candidate RSs to the UE, wherein each candidate RS represents a candidate beam. For example, a candidateBeamRSList as legacy or the like will be configured for a PCell or a PSCell, and a candidateBeamRSSCellList as legacy or the like will be configured for a SCell. Persons skilled in the art should well know, herein, information elements (IE) s or parameters named after the legacy are only illustrated as examples, which may change as the evolution of 3GPP specification, and thus should be not used to unduly limit the protection scope of the present application. To distinguish from the candidate beam, the beams corresponding to RSs in at least one set of RSs related to beam monitoring are also referring to serving beams.

The UE will at least monitor the at least one set of RSs related to beam monitoring to predict whether there will be a beam problem. The predicted beam problems are various. Exemplary predicted beam problems may be one or more of the following:
a) it is predicted that a beam failure will be detected on a cell, e.g., a SCell or a special cell (sPCell, referring to PCell or PSCells);
b) it is predicted that at least one beam failure instance (BFI) indication for the at least one set of RSs related to beam monitoring will be received from lower layers, e.g., layer lower than MAC layer;
c) it is predicted that a value of beam failure instance counter will be incremented or more than a threshold value, e.g., it is predicted that a legacy BFI_COUNTER will be incremented by 1 or more than a threshold value;
d) it is predicted that a beam failure detection timer will start running, e.g., a legacy beamFailureDetectionTimer or the like is predicted to be ‘running’;
e) it is predicted that L1-RSRP will be below a threshold value; and
f) it is predicted that BLER will be above a threshold value.

In step 304, the remote apparatus, e.g., the UE will transmit reporting information related to at least one predicted beam problem to the RAN node, e.g., the gNB. Accordingly, the gNB will receive the reporting information from the UE in step 305. In some embodiments of the present application, no reporting information will be transmitted during a BFR procedure or during a random access procedure in response to a BFR. For example, in the case that a BFR procedure is triggered, either starting random access to the PCell or PSCell or generating a legacy BFR MAC CE, any on-going predicted beam problem report procedure will be stopped or cancelled. Alternatively, the UE is not expected to report information related to the predicted beam problems during the random access procedure in response to a BFR.

In different scenarios, the reporting information may be different, e.g., may be a predicted beam problem report, or a beam management report associated with beam problem prediction, or reporting information indicating that a random access procedure is due to a predicted beam failure, or a combination of any two or three of the above, or a combination of any one or more of the above with other information.

For example, in some scenarios, the reporting information is a predicted beam problem report. An exemplary predicted beam problem report may include one or more items of the following:
a) information indicating whether there is a candidate beam is predicted for a cell (e.g., a candidate beam indicated in a candidateBeamRSList configured for a PCell or a PSCell or a candidate beam indicated in a candidate BeamRSSCellList configured for a SCell) where a beam problem is predicted;
b) information indicating a predicted L1-RSRP value or a BLER value of a candidate beam for a cell (e.g., a candidate beam indicated in a candidate BeamRSList configured for a PCell or a PSCell or a candidate beam indicated in a candidateBeamRSSCellList configured for a SCell) where a beam problem is predicted;
c) time information indicating validity time of the reporting information; and
d) confidence information (e.g., a likelihood) indicating a confidence level of the reporting information, e.g., 90% indicating how likely a predicted beam problem indicated in the reporting information is going to happen.

Regarding the time information, it can be indicated or presented in various manners. For example, the time information may be indicated by a time length, e.g., 10 ms indicating a time window defined by 10 ms in the future. In another example, the time information may be indicated by two time lengths, e.g., 5 ms and 10 ms indicating a time window defined between 5 ms and 10 ms in the future. The time length can be represented by an integer value, e.g., 7, and the unit of the value is predefined or configured by the network side, e.g., 1 ms or 1 slot or 1 symbol etc. For example, the gNB may configure the UE with a time unit value of 5 ms, and then set an integer value to be 4 (e.g., 0000100 in bits) to indicate the UE to perform the beam problem prediction for the next 20 ms. In yet another example, the time information may be indicated by one or more time instances, e.g., at the second slot, or the 6^{th} symbol in the third slot, or between the second slot and fourth slot etc. Herein, a certain time instance can be deemed as a special case of the time window.

In some scenarios, whether to perform the beam problem prediction, how to perform the beam problem prediction, whether to report the predicted beam problem and/or how to report the predicted beam problem etc., can be configured by the network side.

For example, in some embodiments of the present application, the network side may configure an indicator to enable or disable reporting predicted beam problems, e.g., by a RRC signaling. In the case that the indicator indicates to enable reporting predicted beam problems, the UE will transmit the reporting information related to predicted beam problems. In the case that the indicator indicates to disable reporting predicted beam problems, the UE will not transmit the reporting information related to predicted beam problems.

In some embodiments of the present application, the network side may configure a first time window where whether there is a beam problem will be predicted. The first time window can be indicated in various manners similar to the above illustrated time information, e.g., by a time length, or by two time lengths etc. In the case that the first time window is configured, the UE will perform prediction for the configured time window. The UE does not need to indicate the related time information in the reporting information for which the prediction is performed, and the network side can aware the time at that at least one predicted beam problem may occur. For example, the first time window may be indicated by the gNB to be a time length value, e.g., 10 ms, which indicates the UE to perform beam problem prediction within 10 ms in the future; and in the case the gNB receives a predicted beam problem report, the gNB can determine that the predicted beam problem will occur within 10 ms in the future.

The network side may also configure a second time window where information on candidate beam(s) indicated in the reporting information is predicted. Similarly, the second time window can be configured in various manners as the first time window and thus details will not be repeated.

In some embodiments of the present application, the network side may configure a first confidence threshold, e.g., 80%. In the case that likelihood of a beam problem's potential occurrence is above the first confidence threshold, the beam problem will be considered as a predicted beam problem to be reported in the reporting information. For example, when an AI model is provided by the gNB, the gNB may also indicate the first confidence threshold for the UE to determine whether there will be a predicted beam problem by the AI model.

The network side may also configure a second confidence threshold similar to the first confidence threshold. In the case that predicted information of a candidate beam has a confidence level, e.g., 90% above the second confidence threshold, e.g., 70%, the candidate beam will be considered as a candidate beam eligible to be reported in the reporting information. For example, when an AI model is provided by the gNB, the gNB may also indicate the second confidence threshold for the UE to determine whether a candidate beams will be carried in the predicted beam problem report. In some scenarios, the UE may not report all the candidate beams that fulfill the second confidence threshold, and select only part candidate beams, e.g., one candidate beam and report the selected candidate beam(s) in the predicted beam problem report. Exemplary selected candidate beam(s) may be a candidate beam with the highest confidence level, or a candidate beam with the best predicted L1-RSRP or BLER.

In some embodiments of the present application, the network side may also configure a third threshold. In the case that predicted quality, e.g., L1-RSRP or BLER of the set of RSs related to beam monitoring is worse than the third threshold, a beam problem will be predicted and reported in the reporting information. For example, a L1-RSRP can be configured for the UE on a cell corresponding to a configured BFD-RS set. In the case that the UE predicts that the average L1-RSRP the BFD-RS set within the first time window is worse than the third threshold, a predicted beam problem will be determined and will be reported to the gNB.

Similarly, a fourth threshold may also be configured by the network side. In the case that the predicted quality of a candidate beam is better than or equal to the fourth threshold, the candidate beam will be considered as a candidate beam eligible to be reported in the reporting information. The UE may report the candidate beam to the network side or not in different scenarios similar to the above illustrated. For example, in some scenarios, there are more than one candidate beam eligible to be reported, while the UE will only report the candidate beam with the best quality of the more than one candidate beam to the network side.

In some embodiments of the present application, the network side may configure a counter value, e.g., a predictbeamFailureInstanceCount similar to legacy beamFailure InstanceMaxCount. In the case that predicted consecutive times of a beam failure instance is more than the counter value, a beam problem will be predicted and will be reported in the reporting information.

The network side may also configure a prohibition timer. When the prohibition timer is running, no reporting information will be transmitted to the network side from the UE. In some embodiments of the present application, the prohibition timer will start running in response to a beam failure is predicted or the reporting information is generated or transmitted successfully. The prohibition timer will be reset in the case that the at least one set of reference signals related to beam monitoring is reconfigured by the network side.

The reporting information, e.g., a predicted beam problem report or a predicted beam problem report etc. as illustrated above can be transmitted by various manners, e.g., by a MAC CE, a CSI report, or a RRC message. For example, the reporting information can be carried in an IE in a UE assistance information message or a similar RRC message. Regarding the MAC CE and CSI report of carrying the reporting information, detailed embodiments will be illustrated in the following.

According to some embodiments of the present application, in the case that the reporting information, e.g., a predicted beam problem report is transmitted by a MAC CE, a bit map indicating whether a beam problem is predicted in a cell, e.g., a PCell, a PSCell or a SCell may also be included in the MAC CE besides the reporting information illustrated above. For example, “1” means there is a predicted beam problem in the corresponding cell, and “0” means that there is no predicted beam problem in the corresponding cell.

The MAC CE can be a MAC CE associated with a LCID as the same as legacy, e.g., a MAC CE updated based on (or reusing) a legacy MAC CE for BFR, or can be a MAC CE associated with a LCID different from legacy, i.e., a new MAC CE not defined in legacy technology. Regarding the legacy MAC CE for BFR, it consists of either BFR MAC CE or truncated BFR MAC CE. The BFR MAC CE and truncated BFR MAC CE are identified by a MAC subheader with LCID (or enhanced LCID) as specified in Table 6.2.1-2 and Table 6.2.1-2b in TS38.321.

FIG. 4 illustrates an exemplary MAC CE of reporting information related to predicted beam problems according to some embodiments of the present application.

Referring to FIG. 4, the illustrated MAC CE of reporting information related to predicted beam problems reuses the legacy MAC CE for BFR, wherein the fields in the MAC CE of reporting information related to predicted beam problems are defined similarly to the legacy MAC CE for BFR while the SP field and P bit(s) (just for clear description and can be named in other manners, corresponding to legacy R bit(s)) are newly defined as follows.
SP: This field indicates beam problem detection for a cell, e.g., the PCell or PSCell of this MAC entity. The SP field is set to 1 to indicate that beam problem predicted for the cell only when the non-truncated MAC CE or truncated MAC CE of reporting information related to predicted beam problems is to be included into a MAC PDU as part of random access procedure (as specified in 5.1.3a and 5.1.4), otherwise, it is set to 0;
Ci (i=1 . . . 7, corresponding to legacy BFR MAC CE): This field indicates a beam problem, which is either predicted or has occurred (which will be further indicated by the P field) and the presence of an octet containing the availability indication (AC) field for the cell with ServCellIndex i as specified in TS 38.331 [5]. The Ci field set to 1 indicates that there is a beam problem, the evaluation of the candidate beams according to the requirements as specified in TS 38.133 [11] has been completed, and the octet containing the AC field is present for the cell with ServCellIndex i. The Ci field set to 0 indicates that either there is no beam problem or there is a beam problem but the evaluation of the candidate beams according to the requirements as specified in TS 38.133 [11] has not been completed, and the octet containing the AC field is not present for the cell with ServCellIndex i. The octets containing the AC field are present in ascending order based on the ServCellIndex;
Ci (i=1 . . . 7, corresponding to Truncated MAC CE): This field indicates a beam problem, which is either predicted or has occurred (which will be further indicated by the P field) for the cell with ServCellIndex i as specified in TS 38.331 [5]. The Ci field set to 1 indicates that there is a beam problem, the evaluation of the candidate beams according to the requirements as specified in TS 38.133 [11] has been completed, and the octet containing the AC field for the cell with ServCellIndex i may be present. The Ci field set to 0 indicates that the either there is no beam problem or wherein is a beam problem but the evaluation of the candidate beams according to the requirements as specified in TS 38.133 [11] has not been completed, and the octet containing the AC field is not present for the cell with ServCellIndex i. The octets containing the AC field, if present, are included in ascending order based on the ServCellIndex. The number of octets containing the AC field included is maximised, while not exceeding the available grant size;
The number of the octets containing the AC field in the truncated MAC CE can be zero.
AC: This field indicates the presence of the Candidate RS ID field in this octet. If at least one of the SSBs with SS-RSRP above rsrp-ThresholdBER amongst the SSBs in candidateBeamRSSCellList or the CSI-RSs with CSI-RSRP above rsrp-ThresholdBER amongst the CSI-RSs in candidate BeamRSSCellList is available, the AC field is set to 1; otherwise, it is set to 0. If the AC field set to 1, the Candidate RS ID field is present. If the AC field set to 0, R bits are present instead;
Candidate RS ID: This field is set to the index of an SSB with SS-RSRP above rsrp-ThresholdBER amongst the SSBs in candidate BeamRSSCellList or to the index of a CSI-RS with CSI-RSRP above rsrp-ThresholdBER amongst the CSI-RSs in candidateBeamRSSCellList. Index of an SSB or CSI-RS is the index of an entry in candidateBeamRSSCellList corresponding to the SSB or CSI-RS. Index 0 corresponds to the first entry in the candidateBeamRSSCellList, index 1 corresponds to the second entry in the list and so on. The length of this field is 6 bits.
P: This bit corresponds to the reserved bit in MAC CE for BFR, and is used to indicate whether a relevant beam problem and candidate beam information for a corresponding cell is predicted (e.g., a beam failure is predicted rather than being really detected) or has occurred (e.g., a beam failure has been detected). For example, “1” means that the reported beam problem is predicted and “0” means that the reported beam problem is real and has happened. It is similar to candidate beam information indicated in the MAC CE.
R: reserved bits.

It can be seen that, different from the legacy MAC CE for BFR, in the case that the SP field indicates a predicted beam problem in PCell or PSCell, there will be corresponding AC, P, Candidate RS ID field (or bits) present in the MAC CE of reporting information related to predicted beam problems too.

Persons skilled in the art should well know that although the MAC CE illustrated in FIG. 4 is described based on a legacy MAC CE for BFR, other legacy MAC CEs can also be reused or newly defined to be a MAC CE of reporting the predicted beam problems in the same or similar format, and a new MAC CE of reporting the predicted beam problems can also be defined in the same or similar format.

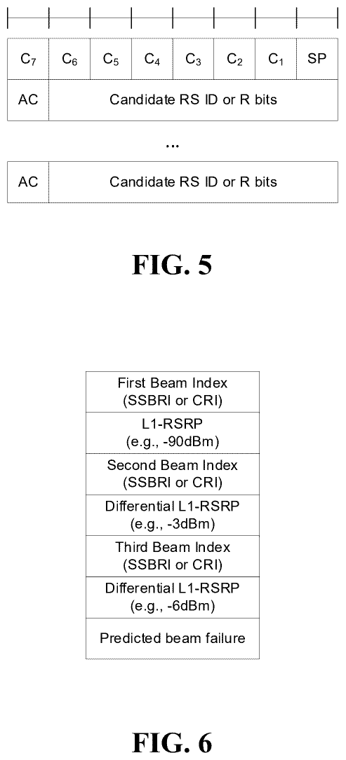

FIG. 5 illustrates another exemplary MAC CE of reporting information related to predicted beam problems according to some other embodiments of the present application.

Referring to FIG. 5, the illustrated MAC CE is associated with a new LCID or legacy LCID, wherein each field, e.g., SP, Ci (i=1 . . . 7), AC and Candidate RS ID can be defined in the same or similar manner as illustrated in FIG. 4, and thus will not be repeated. However, no P bit(s) is defined.

In the case that the reporting information is transmitted by a CSI report, the CSI report may include an indicator indicating the at least one predicted beam problem. For example, when reporting the beam measurement result to a gNB, the UE may use an extra bit to indicate whether the current beam is going to fail, to facilitate the following beam reconfiguration before the beam actually fails. Exemplary CSI report may also include information related to at least one predicted best beam or at least one best candidate beam when the predicted beam problem is going to happen. Exemplary best beam or best candidate beam are beam or candidate beam in best quality, e.g., with high L1-RSRP or low BLER etc. Exemplary candidate beam can be a candidate beam in the candidate BeamRSList or candidate BeamRSSCellList as configured by the gNB.

FIG. 6 illustrates an exemplary CSI report of information related to predicted beam problems according to some embodiments of the present application.

Referring to FIG. 6, the indicator “predicted beam failure” indicates that it is predicted that the current serving beam is going to fail. Indexes of three beams (serving beams), e.g., SSB resource indicator (SSBRI) or CSI-RS resource indicator (CRI), which are with predicted best quality when the predicted beam problem is going to happen, are indicated in the CSI report. The corresponding predicted quality information, e.g., predicted L1-RSRP of each best beam is also indicated in the CSI report. For example, the predicted L1-RSRP of the first best beam is −90 dBm, the differential L1-RSRP of the second best beam is −3 dBm (or the predicted L1-RSRP of the second best beam is −93 dBm), and the differential L1-RSRP of the third best beam is −6 dBm (or the predicted L1-RSRP of the second best beam is −96 dBm). In some other embodiments of the present application, the shown indexes and L1-RSRPs may be related to predicted best candidate beams when the predicted beam problem is going to happen. In some yet other embodiments of the present application, the shown indexes and quality information, e.g., L1-RSRPs may be related to current using beams (or serving beams) or candidate beams indicated in a beam measurement result report same as or similar to the legacy.

In some scenarios, in the case that the reporting information is a beam measurement report or include a beam measurement report, the beam measurement report may be in response to occurrence of any of the following events:
a) a beam failure is detected and corresponding beam failure recovery is successful;
b) a beam problem (including beam failure) is predicted;
c) a beam problem is predicted and a corresponding predicted beam problem report has been transmitted; and
d) a beam problem is predicted, and a corresponding random access is successful.

Accordingly, the beam measurement result included in the beam measurement report may reflect the beam quality within a time period before any time of the following:
a) time that the detected beam failure occurs;
b) time that a corresponding BFR is successful in response to the detected beam failure;
c) time of predicted occurrence of the predicted beam problem;
d) time of transmitting a corresponding predicted beam problem report in response to a predicted occurrence of the predicted beam problem; or
e) time that a corresponding BFR is successful in response to a predicted beam problem.

The beam measurement result included in the report may at least include measurement results for the list of candidate beams configured by the gNB for legacy BFR, or for predicted beam problem reporting, or for random access for predicted beam problem procedure.

Based on the beam measurement report, the remote apparatus can assist the RAN node to understand the quality of beams, e.g., at the time of receiving a predicted beam problem report from the remote apparatus.

The beam measurement report can be a CSI report or a RRC report, e.g., as the same as a CSI or RRC report of predicted beam problems as illustrated above, or in a different CSI report or RRC report similar to the legacy. In the case that a protocol layer that predicts a beam problem is different from a protocol layer of the beam measurement report, the beam measurement report can be triggered by a cross layer indication. For example, in the case that the protocol layer that predicts beam problem(s) is MAC layer or a new protocol layer associated with AI operation, which is different from physical (PHY) layer for a CSI report conveying the beam measurement result, the MAC layer or a new protocol layer associated with AI operation or other protocol layer will transmit indication information to the PHY layer to trigger the beam measurement report. Similarly, in the case that the protocol layer that predicts beam problem(s) is MAC layer or a new protocol layer associated with AI operation, which is different from RRC layer conveying the beam measurement result, the MAC layer or a new protocol layer associated with AI operation or PHY layer or other protocol layer will transmit indication information to the RRC layer to trigger the beam measurement report.

In some scenarios, e.g., there is not much uplink and/or downlink traffic, in the case that it is predicted that at least one beam problem will occur in a PCell or a PSCell, that is, a beam failure has not occur or has not been detected yet, the UE may initiate a random access procedure in advance using a candidate beam, e.g., a candidate beam indicated in a candidateBeamRSList as configured by the gNB.

Some conditions can be defined or configured for the UE to initiate such as random access procedure in advance. For example, only in the case that a predicted beam failure will happen in a PCell or a PSCell within a certain time window, will the UE trigger initiating a random access due to the predicted beam problem. In another example, a threshold level may be configured. Only in the case that a predicted beam failure will happen in a PCell or PSCell with a likelihood above the threshold level, will the UE trigger initiating the random access due to predicted beam problem.

To distinguish from the legacy random access due to occurred beam failure, the UE will transmit reporting information to indicate that the random access is due to a predicted beam failure during or after the random access procedure. For example, dedicated resources for random access (e.g., contention free random access) corresponding to reporting information related to predicted beams are configured. Alternatively, after the random access succeeds, the UE will send a MAC CE or RRC message to the gNB to indicate that the random access was not due to a really occurred beam failure.

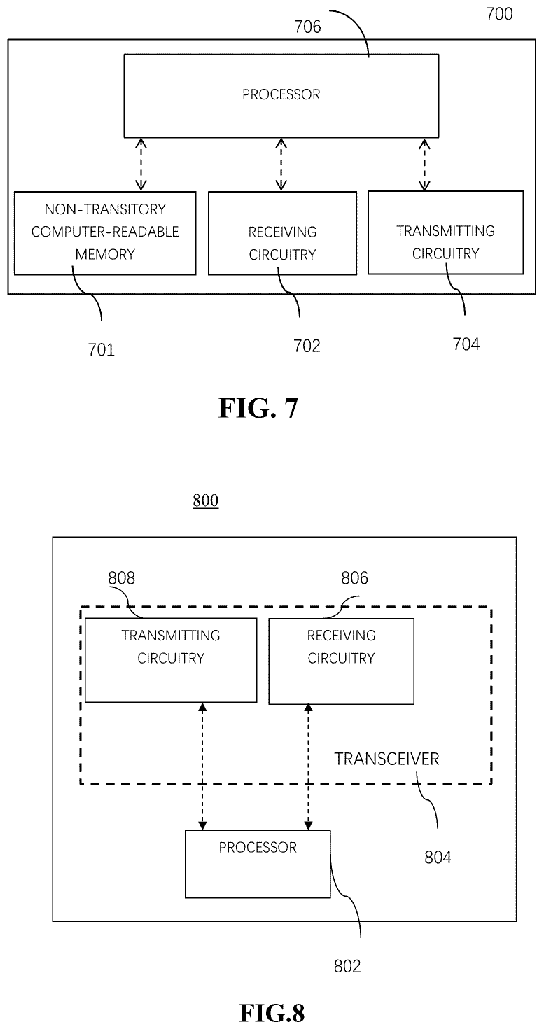

Some embodiments of the present application also provide an apparatus of supporting beam problem prediction. For example, FIG. 7 illustrates a block diagram of an apparatus of supporting beam problem prediction 700 according to some embodiments of the present application.

As shown in FIG. 7, the apparatus 700 may include at least one non-transitory computer-readable medium 701, at least one receiving circuitry 702, at least one transmitting circuitry 704, and at least one processor 706 coupled to the non-transitory computer-readable medium 701, the receiving circuitry 702 and the transmitting circuitry 704. The at least one processor 706 may be a CPU, a DSP, a microprocessor etc. The apparatus 700 may be a RAN node configured to perform a method illustrated in the above or the like.

Although in this figure, elements such as the at least one processor 706, transmitting circuitry 704, and receiving circuitry 702 are described in the singular, the plural is contemplated unless a limitation to the singular is explicitly stated. In some embodiments of the present application, the receiving circuitry 702 and the transmitting circuitry 704 can be combined into a single device, such as a transceiver. In certain embodiments of the present application, the apparatus 700 may further include an input device, a memory, and/or other components.

In some embodiments of the present application, the non-transitory computer-readable medium 701 may have stored thereon computer-executable instructions to cause a processor to implement the method with respect to a remote apparatus, e.g., a UE as described above. For example, the computer-executable instructions, when executed, cause the processor 706 interacting with receiving circuitry 702 and transmitting circuitry 704, so as to perform the steps with respect to a remote apparatus as depicted above, e.g., shown in FIG. 3.

In some embodiments of the present application, the non-transitory computer-readable medium 701 may have stored thereon computer-executable instructions to cause a processor to implement the method with respect to a RAN node, e.g., a gNB as described above. For example, the computer-executable instructions, when executed, cause the processor 706 interacting with receiving circuitry 702 and transmitting circuitry 704, so as to perform the steps with respect to a RAN node as depicted above, e.g., shown in FIG. 3.

FIG. 8 is a block diagram of an apparatus of supporting beam problem prediction 800 according to some other embodiments of the present application.

Referring to FIG. 8, the apparatus 800, for example a UE or a gNB may include at least one processor 802 and at least one transceiver 804 coupled to the at least one processor 802. The transceiver 804 may include at least one separate receiving circuitry 806 and transmitting circuitry 808, or at least one integrated receiving circuitry 806 and transmitting circuitry 808. The at least one processor 802 may be a CPU, a DSP, a microprocessor etc.

According to some embodiments of the present application, when the apparatus 800 is a remote apparatus, e.g., a UE, the processor is configured to: receive, via the transceiver, configuration information on a set of RSs related to beam monitoring; and transmit, via the transceiver, reporting information related to at least one beam problem, wherein the at least one beam problem is predicted by monitoring at least the set of RSs related to beam monitoring.

According to some other embodiments of the present application, when the apparatus 800 is a RAN node, e.g., a gNB, the processor may be configured to: transmit, via the transceiver, configuration information on a set of RSs related to beam monitoring; and receive, via the transceiver, reporting information related to at least one beam problem, wherein the at least one beam problem is predicted by monitoring at least the set of RSs related to beam monitoring.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A remote apparatus for wireless communication, comprising:
at least one memory; and
at least one processor coupled with the at least one memory and configured to cause the remote apparatus to:
receive configuration information on at least one set of reference signals (RSs) related to beam monitoring; and
transmit reporting information related to at least one beam problem, wherein the at least one beam problem is predicted by at least monitoring the at least one set of RSs related to beam monitoring.

2. The remote apparatus of claim 1, wherein the predicted at least one beam problem comprises one or more of the following:
a beam failure will be detected on a cell;
at least one beam failure instance indication for the at least one set of RSs related to beam monitoring will be received from lower layers;
a value of a beam failure instance counter will be incremented of more than a threshold value;
a beam failure detection timer will start running;
an L1-reference signal receiving power (RSRP) will be below a threshold value; and
a block error rate (BLER) will be above a threshold value.

3. The remote apparatus of claim 1, wherein the at least one processor is further configured to cause the remote apparatus to receive one or more of the following:
an indicator to enable or disable reporting predicted beam problems;
a first time window in which a beam problem will be predicted;
a second time window in which information on candidate beams indicated in the reporting information is predicted;
a first confidence threshold, wherein when an occurrence likelihood of a beam problem is above the first confidence threshold, the beam problem will be considered as a predicted beam problem to be reported in the reporting information;
a second confidence threshold, wherein when predicted information of a candidate beam has a confidence level above the second confidence threshold, the candidate beam will be considered as a candidate beam eligible to be reported in the reporting information;
a third threshold, wherein when a predicted quality of the at least one set of RSs related to beam monitoring is worse than the third threshold, a beam problem will be predicted and reported in the reporting information;
a fourth threshold, wherein when a predicted quality of a candidate beam is better than or equal to the fourth threshold, the candidate beam will be considered as a candidate beam eligible to be reported in the reporting information;
a counter value, wherein when a predicted consecutive times of a beam failure instance is more than the counter value, a beam problem will be considered as a predicted beam problem to be reported in the reporting information;
a prohibition timer, wherein no reporting information will be transmitted when the prohibition timer is running; and
a time unit value that is used to set time information in the reporting information.

4. The remote apparatus of claim 3, wherein the prohibition timer will start running in response to a beam failure being predicted or the reporting information is generated or transmitted successfully.

5. The remote apparatus of claim 1, wherein no reporting information will be transmitted during a beam failure recovery (BFR) procedure or during a random access procedure in response to a BFR.

6. The remote apparatus of claim 1, wherein the reporting information is a predicted beam problem report, comprising one or more of the following:
information indicating whether a candidate beam is predicted for a cell where a beam problem is predicted;
information indicating a predicted L1-reference signal receiving power (RSRP) value or a block error rate (BLER) value of a candidate beam for a cell where a beam problem is predicted;
time information indicating validity time of the reporting information; and
confidence information indicating a confidence level of the reporting information.

7. The remote apparatus of claim 1, wherein, the reporting information is transmitted by a media access control (MAC) control element (CE), a channel state information (CSI) report, or a radio resource control (RRC) message.

8. The remote apparatus of claim 7, wherein, when the reporting information is transmitted by a MAC CE, the reporting information comprises:
a bit map indicating whether a beam problem is predicted in a cell.

9. The remote apparatus of claim 7, wherein, the MAC CE is associated with a logical channel identifier (LCID) different from legacy or same as legacy, and when the MAC CE is associated with an LCID that is the same as legacy, a bit corresponding to a reserved bit in a legacy MAC CE is used to indicate whether a relevant beam problem and candidate beam information for a corresponding cell is predicted or has occurred, and a field in legacy MAC CE is used to indicate a predicted beam problem in a primary cell (PCell) or a primary secondary cell (PSCell).

10. The remote apparatus of claim 7, wherein, when the reporting information is transmitted by a CSI report, the CSI report comprises an indicator indicating the at least one predicted beam problem.

11. The remote apparatus of claim 7, wherein, when the reporting information is transmitted by an RRC message, the reporting information is carried in an information element in a user equipment (UE) assistance information message.

12. The remote apparatus of claim 1, wherein the reporting information is a beam measurement report in response to occurrence of any of the following events:
a beam failure is detected and corresponding beam failure recovery is successful;
a beam problem is predicted;
a beam problem is predicted and a corresponding predicted beam problem report has been transmitted; or
a beam problem is predicted, and a corresponding random access is successful.

13. The remote apparatus of claim 1, wherein the reporting information is transmitted during or after a random access procedure initiated with a candidate beam, and indicates that the random access procedure is due to a predicted beam failure.

14. A radio access network (RAN) node for wireless communication, comprising:
at least one memory; and
at least one processor coupled with the at least one memory and configured to cause the RAN node to:
transmit configuration information on at least one set of reference signals (RSs) related to beam monitoring; and
receive reporting information related to at least one beam problem, wherein the at least one beam problem is predicted by at least monitoring the at least one set of RSs related to beam monitoring.

15. A method performed by a remote apparatus, the method comprising:
receiving configuration information on at least one set of reference signals (RSs) related to beam monitoring; and
transmitting reporting information related to at least one beam problem, wherein the at least one beam problem is predicted by at least monitoring the at least one set of RSs related to beam monitoring.

16. The method of claim 15, wherein the reporting information is transmitted by a media access control (MAC) control element (CE), a channel state information (CSI) report, or a radio resource control (RRC) message.

17. The method of claim 15, wherein the reporting information is a beam measurement report in response to occurrence of any of the following events:
a beam failure is detected and corresponding beam failure recovery is successful;
a beam problem is predicted;
a beam problem is predicted and a corresponding predicted beam problem report has been transmitted; or
a beam problem is predicted, and a corresponding random access is successful.

18. The method of claim 15, wherein the reporting information is transmitted during or after a random access procedure initiated with a candidate beam, and indicates that the random access procedure is due to a predicted beam failure.

19. The method of claim 15, wherein no reporting information will be transmitted during a beam failure recovery (BFR) procedure or during a random access procedure in response to a BFR.

20. A method performed by a radio access network (RAN) node, the method comprising:
transmitting configuration information on at least one set of reference signals (RSs) related to beam monitoring; and
receiving reporting information related to at least one beam problem, wherein the at least one beam problem is predicted by at least monitoring the at least one set of RSs related to beam monitoring.
